(19) United States
(12) Patent Application Publication
(10) Pub. No.: US 2025/0391581 A1
(43) Pub. Date: Dec. 25, 2025

(54) MULTI-USE MOVABLE INCORE SYSTEM TO SUPPORT REACTOR POWER DISTRIBUTION MEASUREMENTS AND RADIOISOTOPE PRODUCTION ACTIVITIES

(71) Applicant: Westinghouse Electric Company LLC, Cranberry Township, PA (US)

(72) Inventors: Michael D. Heibel, Broomfield, CO (US); Christopher J. Black, Manor, PA (US); Matthew D. McArdle, Murrysville, PA (US)

(73) Assignee: Westinghouse Electric Company LLC, Cranberry Township, PA (US)

(21) Appl. No.: 18/751,288

(22) Filed: Jun. 23, 2024

(51) Int. Cl. G21C 19/20; G21C 17/108; G21C 17/116; G21G 1/02

(52) U.S. Cl. CPC G21C 19/20; G21C 17/108; G21C 17/116; G21G 1/02

(57) ABSTRACT

A multi-use incore system for use with a nuclear reactor having a reactor core including an instrumentation tube is disclosed. The multi-use incore system comprises a drive cable, a neutron detector, an electromagnetic tool, and an irradiation target. The drive cable comprises an adapter at its distal end. The drive cable is slidably receivable into the instrumentation tube. The neutron detector is removably attachable to the adapter of the drive cable to monitor core power distribution. The neutron detector is slidably receivable into the instrumentation tube by the drive cable. The electromagnetic tool is removably attachable to the adapter of the drive cable in lieu of the neutron detector. The irradiation target is to produce a radioisotope. The drive cable is selectively attachable to the irradiation target by the electromagnetic tool to insert the irradiation target into the instrumentation tube and remove the irradiation target from the instrumentation tube.

### FIELD

The present disclosure is generally related to nuclear power generation and, more particularly, is directed toward an incore system that can support reactor power distribution measurements and radioisotope production activities within a nuclear reactor, among other functions.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a multi-use incore system for use with a nuclear reactor is disclosed. The nuclear reactor comprises a reactor core including an instrumentation tube extending into the reactor core. The multi-use incore system comprises a drive cable, a neutron detector, an electromagnetic tool, and an irradiation target. The drive cable comprises an adapter at its distal end. The drive cable is slidably receivable into the instrumentation tube. The neutron detector is removably attachable to the adapter of the drive cable to monitor core power distribution. The neutron detector is slidably receivable into the instrumentation tube by the drive cable. The electromagnetic tool is removably attachable to the adapter of the drive cable in lieu of the neutron detector. The irradiation target is to produce a radioisotope. The drive cable is selectively attachable to the irradiation target by the electromagnetic tool to insert the irradiation target into the instrumentation tube and remove the irradiation target from the instrumentation tube.

In various aspects, an incore system for use with a nuclear reactor is disclosed. The nuclear reactor comprises a reactor core including an instrumentation tube extending into the reactor core. The incore system comprises a drive cable, a neutron detector, a rabbit connector, and a rabbit assembly. The drive cable comprises an adapter at its distal end. The neutron detector is removably attachable to the adapter of the drive cable. The rabbit connector is removably attachable to the adapter of the drive cable in lieu of the neutron detector. The rabbit assembly is selectively attachable to the drive cable by way of the rabbit connector. The incore system is operable in a plurality of configurations. The plurality of configurations comprises a first configuration and a second configuration. In the first configuration the neutron detector is attached to the adapter and is insertable into and removable from the instrumentation tube by the drive cable. In the second configuration the rabbit connector is attached to the adapter of the drive cable, the rabbit assembly is releasably attached to the drive cable by way of the rabbit connector, and the rabbit assembly is insertable into and removable from the instrumentation tube by the drive cable.

In various aspects, an incore system for use with a nuclear reactor is disclosed. The nuclear reactor comprises a reactor core including an instrumentation tube extending into the reactor core. The incore system comprises a drive cable, a neutron detector, and an irradiation target. The drive cable is movable within the instrumentation tube. The neutron detector is selectively attachable to the drive cable. The irradiation target is selectively attachable to the drive cable in lieu of the neutron detector. The incore system is operable in a plurality of configurations. The plurality of configurations comprises a first configuration and a second configuration. In the first configuration the neutron detector is attached to the drive cable and the neutron detector is slidably receivable into the instrumentation tube. In the second configuration the irradiation target is attached to the drive cable and the irradiation target is slidably receivable into the instrumentation tube.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 is a schematic representation of an existing movable incore detector system for use with a nuclear reactor, in accordance with at least one aspect of the present disclosure;

FIG. 2 is partial cross section view of a multi-use drive cable for use with the movable incore detector system of FIG. 1, illustrating multiple different attachments which are removably attachable to the multi-use drive cable, in accordance with at least one aspect of the present disclosure;

FIG. 3 is a cross section view of an instrumentation tube of a reactor core illustrating the multi-use drive cable of FIG. 2 with an electromagnetic tool removably attached thereto for inserting, parking, and retrieving one or more than one irradiation targets, e.g., rabbits, in accordance with at least one aspect of the present disclosure; and

FIG. 4 is a partial perspective view of a nuclear reactor illustrating a rabbit harvesting system (RHS), rabbit guide tubes, and a containment feed through in the reactor containment building wall, in accordance with at least one aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

In the following description, reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

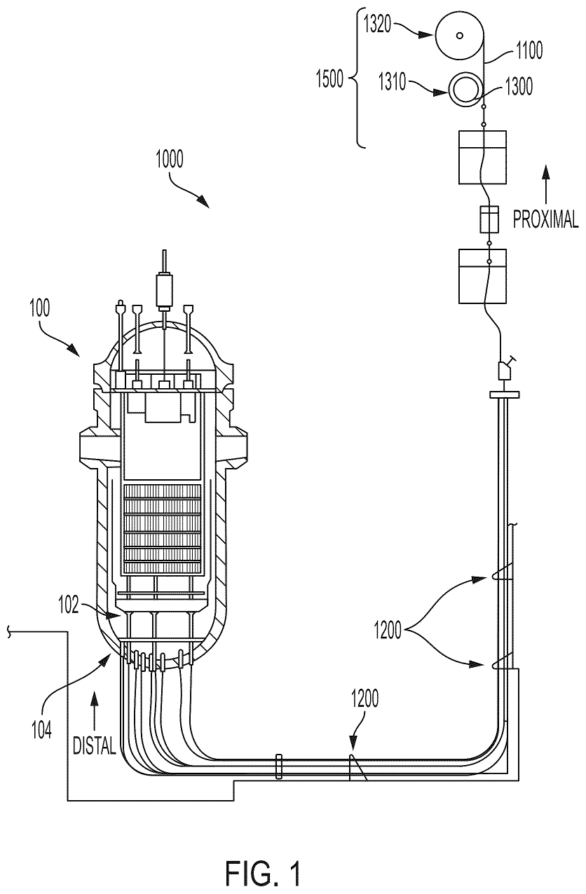

Before explaining various aspects of the incore system for use with a nuclear reactor in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples. The Westinghouse Movable Incore Detector System (MIDS) is used in most vintage Westinghouse-style pressurized water reactor (PWR) designs to insert and withdraw miniature fission chamber neutron detectors into the reactor core during reactor operation. FIG. 1 is a schematic representation of a typical MIDS 1000 for use with a reactor core 100. In at least one aspect, the reactor core 100 comprises instrumentation tubes 102 which are typically accessed through a number of narrow penetrations 104 connected to reactor core instrumentation tubing 1200 of a separate target transfer system. In at least one aspect, the miniature fission chamber neutron detectors are attached to the distal ends of drive cables 1100 and are insertable into and removable from the reactor core instrumentation tubing 1200 and instrumentation tubes 102 by way of a cable drive unit 1500 comprising a motor 1300 which drives the drive cables 1100. Each cable drive unit 1500 comprises a drive motor 1300, a drive wheel 1310, and a storage reel 1320. In at least one aspect, the fission chamber neutron detectors are welded to the ends of the drive cables 1100 and therefore the drive cables 1100 must remain extended while the fission chamber neutron detectors are positioned in the instrumentation tubes 102 of the reactor core 100 for monitoring core power distribution. As such, in the event that the miniature fission chamber detector goes bad, the entire cable 1100 must be replaced due to the miniature fission chamber detector being welded to the end of the cable 1100. Further, it should be understood that the reactor core 100 has several instrumentation tubes 102, 1200 which can receive separate neutron detectors therein.

Further to the above, the signal data obtained from the fission chamber neutron detectors is used to produce the core power distribution measurements required at intervals specified in the plant's technical specifications. In various aspects, the MIDS 1000 can be used to insert and withdraw material into the reactor core 100 that will turn into medical and/or other commercially valuable radioisotopes after being irradiated while positioned in the instrumentation tubes 102 in the reactor core 100. The existing need to perform the periodic core power distribution measurements limits the amount of use that the MIDS 1000 may devote to the production of medical radioisotopes. It may be possible to add additional motors and drive cables solely dedicated to radioisotope production. However, such modifications may result in radioisotope production and operation costs that significantly reduce the commercial viability of using the MIDS for radioisotope production. The costs associated with this approach is a large impediment to using the capability of commercial reactors to produce the radioisotopes needed to produce an adequate supply of the latest radiopharmaceuticals used for a large number of new cancer treatments, among other applications.

In various aspects, the existing MIDS cable design is modified to allow each existing MIDS drive motor system to be used to perform core power distribution measurements and radioisotope production. In at least one aspect, a motor drive and associated multi-use drive-cable allows each radiation detector used for periodic reactor power distribution measurements to be replaced with an irradiation target (e.g., rabbit) that is used to create the desired radioisotopes, among other attachments. As such, the multi-use drive cable allows every motor drive in an existing MIDS to perform both power distribution and radioisotope production activities, among other functions. In at least one aspect, the multi-use drive cable eliminates the need to add extra dedicated radioisotope production MIDS cable drive hardware that could significantly add to the complexity and cost of radioisotope production. The modified MIDS used to implement the desired capabilities is described in greater detail below.

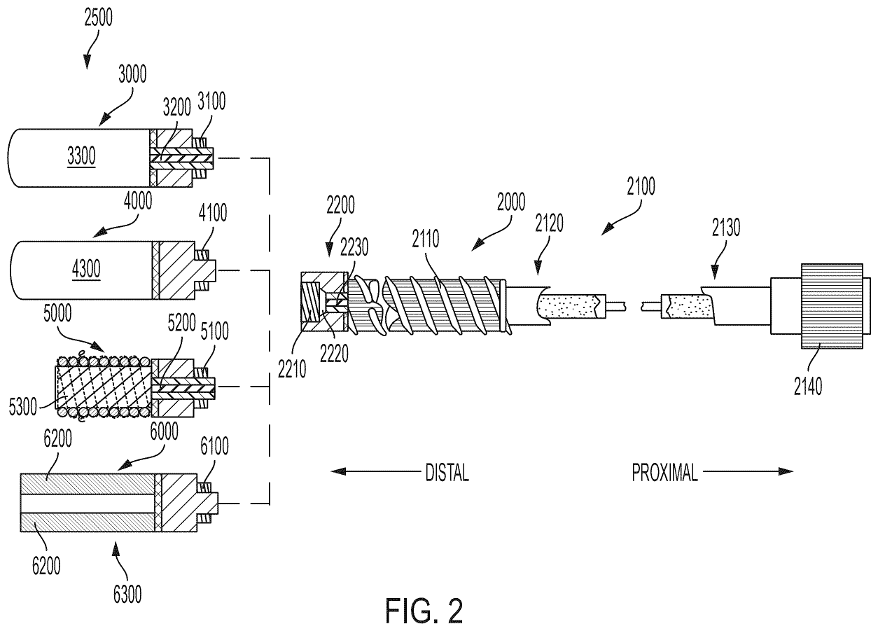

Turning now to FIG. 2 which illustrates a multi-use drive cable 2000 for use with an existing movable incore detector system (MIDS) such as the MIDS 1000 in FIG. 1. In at least one aspect, a plurality of multi-use drive cables 2000 can replace the drive cables 1100 of the MIDS 1000, for example. Each drive cable 2000 comprises a cable portion 2100 and an adapter 2200 attached to the distal end of the cable portion 2100. In at least one aspect, the cable portion 2100 comprises a helical wrapped portion 2110, a mineral filled coaxial cable portion 2120, a coaxial cable portion 2130, and a connector portion 2140. In at least one aspect, the coaxial cable portion 2130 is an RG174U coaxial cable or equivalent. In at least one aspect, the connector portion 2140 is a subminax connector or equivalent. In at least one aspect, the adapter 2200 is welded to the distal end of the cable portion 2100. In at least one aspect, the adapter 2200 is attached to the distal end of the cable portion 2100 by any suitable attachment means such as pinning, soldering, brazing, mechanical fastening, riveting, adhesive bonding, etc., or combinations thereof. Further, in various aspects, the cables described herein may be comprised of one or more than one electrical conductor for transmitting electrical signals and/or for transmitting power.

Further to the above, the adapter 2200 comprises a threaded opening 2210 defined therein at its distal end, a coaxial cable portion 2230, and a countersunk region 2220 extending proximally from the threaded opening 2210 toward the coaxial cable portion 2230. In at least one aspect, the coaxial cable portion 2230 is defined in the adapter 2200 such that the adapter 2200 completely surrounds the coaxial cable portion 2230. Further, in at least one aspect, the coaxial cable portion 2230 is coupled to the coaxial cable portions 2120, 2130 of the cable portion 2100 of the drive cable 2000. As such, power and/or electrical signals can be transferred between the coaxial cable portions 2120, 2130 of the cable portion 2100 and the coaxial cable portion 2230 of the adapter 2200. In at least one aspect, the coaxial cables described herein may be mineral filled coaxial cables. In any event, as will be described in greater detail below, the adapter 2200 of the drive cable 2000 permits several different components to be removably attached to the drive cable 2000 by way of the threaded opening 2210 of the adapter 2200.

Referring again to FIG. 2 which illustrates a plurality of attachments 2500 that are separately attachable to the drive cable 2000. In at least one aspect, the attachments 2500 comprise a neutron detector 3000, an irradiation capsule 4000, an electromagnetic tool 5000, and a cleaning device 6000. In at least one aspect, the neutron detector 3000, the irradiation capsule 4000, the electromagnetic tool 5000, and the cleaning device 6000 are separately removably attachable to the drive cable 2000 by way of the threaded opening 2210. By way of example, the neutron detector 3000 may be initially attached to the drive cable 2000. After performing monitoring duties in the reactor core 100, the drive cable 2000 and neutron detector 3000 can be retracted and the neutron detector can be replaced with another one of the attachments 2500 such as the electromagnetic tool 5000. In any event, each of the attachments 2500 will be described in greater detail below.

The neutron detector 3000 illustrated in FIG. 2 comprises a threaded protrusion 3100, a coaxial cable portion 3200, and a detector portion 3300. The threaded protrusion 3100 is threadably engageable with the threaded opening 2210 of the adapter 2200 of the drive cable 2000 to removably attach the neutron detector 3000 to the drive cable 2000. Further, while the neutron detector 3000 is attached to the drive cable 2000, the coaxial cable portion 3200 of the neutron detector 3000 is aligned with and electrically coupled to the coaxial cable portion 2230 of the adapter 2200 of the drive cable 2000. As such, electrical signals can be transmitted from the drive cable 2000 to the neutron detector 3000 and from the neutron detector 3000 to the drive cable 2000.

Further, the electrical wires (e.g., coaxial cables 2130, 2120, 2230, 3200) within the cable portion 2100, the adapter 2200, and the neutron detector 3000 permit the electric current output from the neutron detector 3000 to be transmitted to a slipring device within the drive unit 1500 of the MIDS 1000. The electrical current output can then be transmitted from the slipring device through existing MIDS electrical penetrations in the reactor containment building wall to the electric current measurement and supply hardware located outside the reactor containment building.

In use, while the neutron detector 3000 is attached to the drive cable 2000, the drive cable 2000 can be driven by the drive motor 1300 of the MIDS 1000 until the neutron detector 3000 is slidably received in the instrumentation tube 102 in the reactor core 100. The neutron detector 3000 can monitor core power distribution during reactor operation during a monitoring operation and transmit data indicative of core power distribution to the electric current measurement and supply hardware located outside the reactor containment building. In at least one aspect, once the monitoring operation is complete, the drive cable 2000 can be retracted by the drive motor 1300 to pull the neutron detector 3000 proximally out of the reactor core 100 and into a region where the neutron detector 3000 can be detached from the drive cable 2000 and replaced with another attachment, such as any of the attachments 2500 illustrated in FIG. 2, for example. In at least one aspect, the neutron detector 3000 is attachable to and detachable from the drive cable 2000 within a glove box positioned outside of the reactor containment building, as described in greater detail below.

Further to the above, in various aspects, the detector portion 3300 of the neutron detector 3000 may be of the type(s) described in U.S. Pat. No. 11,715,577 entitled “DETECTORS, SYSTEMS, AND METHODS FOR CONTINUOUSLY MONITORING NEUTRONS WITH ENHANCED SENSITIVITY” which issued on Aug. 1, 2023. The disclosure of U.S. Pat. No. 11,715,577 is incorporated by reference herein in its entirety.

Referring again to FIG. 1, in at least one aspect, the miniature fission chamber neutron detectors attached to the drive cables 1100 of the MIDS 1000 may comprise highly enriched special nuclear material (e.g., greater than 95% enriched U-235) which may have significantly long-lived radioactive effects after use. In at least one aspect, the neutron detector 3000 does not comprise any highly enriched special nuclear material. As such, using the neutron detector 3000 in conjunction with the drive cable 2000, as discussed above, may provide several benefits. Specifically, the neutron detector 3000 will not have any significant long-lived radioactive sources that may make it dangerous and/or expensive to handle after use. Therefore, after use in the reactor core, the neutron detector 3000 can easily be replaced with any of the attachments 2500 illustrated in FIG. 2, for example, without having to deal with the complications of handling irradiated highly enriched special nuclear material.

Further to the above, the attachments 2500 of FIG. 2 comprise the irradiation capsule 4000. The irradiation capsule 4000 comprises a threaded protrusion 4100 and a capsule portion 4300 for use in radioisotopes production. In at least one aspect, the capsule portion 4300 comprises one or more than one material to be irradiated when placed inside the reactor core 100. The threaded protrusion 4100 is threadably engageable with the threaded opening 2210 of the adapter 2200 of the drive cable 2000 to removably attach the irradiation capsule 4000 to the drive cable 2000.

In use, while the irradiation capsule 4000 is attached to the drive cable 2000, the drive cable 2000 can be driven by the drive motor 1300 of the MIDS 1000 until the irradiation capsule 4000 is inserted into the instrumentation tube 102 in the reactor core 100. The material within the irradiation capsule 4000 will be irradiated while positioned within the instrumentation tube 102 during reactor operation to create the desired radioisotope. Once the irradiation capsule 4000 has been irradiated for a period of time, the drive cable 2000 can be retracted by the drive motor 1300 to pull the irradiation capsule 4000 proximally out of the reactor core 100 and into a region where the irradiation capsule 4000 can be detached from the drive cable 2000 and replaced with another attachment, such as any of the attachments 2500 illustrated in FIG. 2, for example. In at least one aspect, the irradiation capsule 4000 is attachable to and detachable from the drive cable 2000 within a glove box positioned outside of the reactor containment building, as described in greater detail below.

Further to the above, in at least one aspect, it may be desirable to position an irradiation capsule for a long period of time within the reactor core 100 for radioisotope production. In such instances, it may be desirable to leave the irradiation capsule behind (e.g., park the irradiation capsule) and retract the drive cable 2000 out of the reactor core 100 to prevent irradiating the drive cable 2000 for a long period of time. In at least one aspect, radioisotope production may be performed using an insertable and retractable irradiation capsule system that includes one or more than one stainless steel irradiation capsule, also known to those skilled in the art as “rabbits.” Rabbits contain material to be irradiated when placed inside the reactor core. The rabbits are irradiated for different periods of time depending on the isotope within the rabbit. To irradiate the rabbits, the rabbits are left inside the nuclear reactor for a period of time.

Further to the above, the electromagnetic tool 5000 illustrated in FIG. 2 permits the drive cable 2000 to “park”, or leave behind, one or more than one irradiation capsules (e.g., rabbits) within the instrumentation tube 102 of the reactor core 100 at a desired position. The drive cable 2000 and the electromagnetic tool 5000 can then be retracted proximally out of the reactor core 100. When the parked rabbit has been irradiated for a period of time, the drive cable 2000 and the electromagnetic tool 5000 can then be used to retrieve the irradiated rabbits from the reactor core 100.

Further to the above, referring again to FIG. 2, the electromagnetic tool 5000 comprises a threaded protrusion 5100, a coaxial cable portion 5200, and an electromagnet 5300. The threaded protrusion 5100 is threadably engageable with the threaded opening 2210 of the adapter 2200 of the drive cable 2000 to removably attach the electromagnetic tool 5000 to the drive cable 2000. Further, while the electromagnetic tool 5000 is attached to the drive cable 2000, the coaxial cable portion 5200 of the electromagnetic tool 5000 is aligned with and electrically coupled to the coaxial cable portion 2230 of the adapter 2200 of the drive cable 2000. As such, electrical power can be transmitted from the drive cable 2000 to the electromagnetic tool 5000 to energize the electromagnet 5300 to perform rabbit insertion and recovery operations.

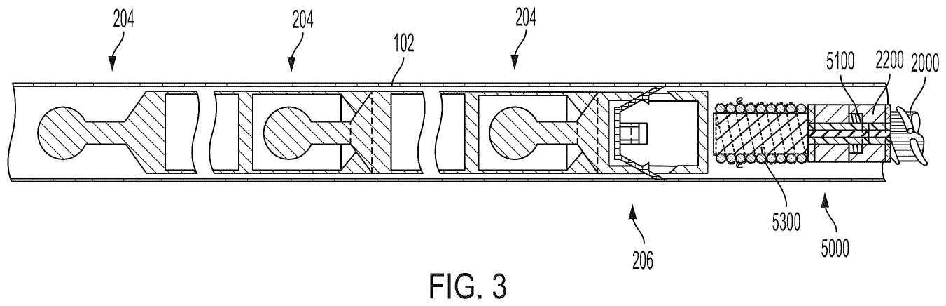

FIG. 3 illustrates a plurality of rabbits 204 including a bottom-most parking rabbit 206 where the rabbits 204 have been parked within the instrumentation tube 102 by way of the parking rabbit 206. In at least one aspect, the plurality of rabbits 204 comprise a rabbit assembly. In any event, the parking rabbit 206 maintains the position of the plurality of rabbits 204 within the instrumentation tube 102 by providing a sufficient frictional force against an inner wall of the instrumentation tube 102. The drive cable 2000 with the electromagnetic tool 5000 attached thereto is used to insert and position the plurality of rabbits 204 in the instrumentation tube 102 at a desired location and then park the rabbits 204 while retracting the drive cable 2000 and electromagnetic tool 5000. At the end of irradiation, the drive cable 2000 with the electromagnetic tool 5000 attached thereto is reinserted to connect to the rabbits 204 and disengage the mechanical apparatus of the parking rabbit 206 which parks the rabbits 204. The drive cable 2000 can then be retracted to retrieve the plurality of rabbits 204 from the instrumentation tube 102. The insertion, parking, and retrieval of rabbits from within a reactor core instrumentation tube is described in greater detail in U.S. patent application Ser. No. 18/064,274 entitled “ELECTROMAGNETICALLY DEPLOYABLE AND RETRACTABLE IRRADIATION CAPSULE HOLDING MECHANISM” filed on Dec. 11, 2022. The disclosure of U.S. patent application Ser. No. 18/064,274 is hereby incorporated by reference herein in its entirety. In various aspects, the electromagnetic tool 5000 and parkable rabbits 204 may be of the types described in U.S. patent application Ser. No. 18/064,274.

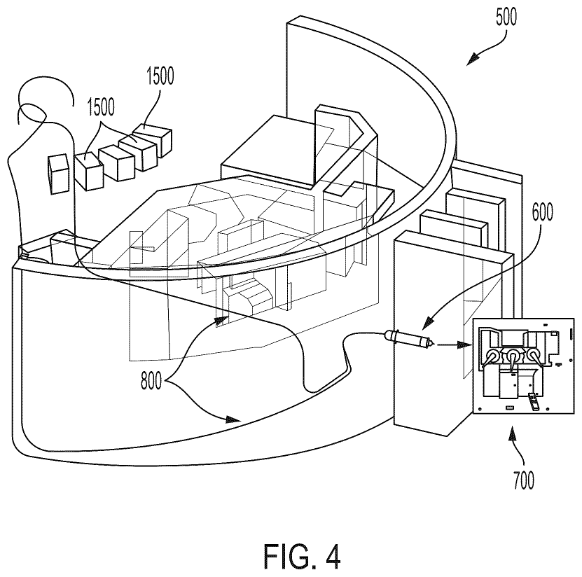

Further to the above, the multi-use drive cable 2000 supports the ability to sense changes in supplied electric current oscillations that indicate whether the rabbit has become detached from the drive-cable and allows the detection of changes in the flux thimble wall thickness that indicates excessive mechanical wear. Specifically, FIG. 4 of U.S. patent application Ser. No. 18/064,274 provides a functional schematic illustration of the instrumentation used to support the electric current supply and measurement function. Further, the electromagnetic tool 5000, when attached to the drive cable 2000, may also be used to attract ferromagnetic particles inside the flux thimble tubes caused by friction between the rabbit and the flux thimble tubes to prevent the accumulation of deposits that may interfere with rabbit or detector insertion and withdrawal.

As discussed above, while the electromagnetic tool 5000 is attached to the drive cable 2000, the drive cable 2000 can be used to insert one or more than one irradiation capsules, or rabbits 204, into the instrumentation tube 102 of the reactor core 100 and park the rabbits 204 at a desired location within the instrumentation tube 102 to allow the drive cable 2000 and the electromagnetic tool 5000 to be retracted out of the reactor core 100. In at least one aspect, the electromagnetic tool 5000 permits the drive cable 2000 to be selectively attachable to the irradiation targets, or rabbits 204, 206. Once the rabbit(s) have been irradiated for a period of time, the drive cable 2000 and the electromagnetic tool 5000 can retrieve the rabbits from the reactor core 100. The drive cable 2000 is then retracted by the drive motor 1300 to pull the rabbits 204 and the electromagnetic tool 5000 out of the reactor core 100 and into a region where the rabbits 204 can be detached from the electromagnetic tool 5000. Further, in this region, the electromagnetic tool 5000 can be detached from the drive cable 2000 and replaced with another attachment, such as any one of the attachments 2500 illustrated in FIG. 2, for example. In at least one aspect, the electromagnetic tool 5000 and/or rabbits 204 are attachable to and detachable from the drive cable 2000 within a glove box positioned outside of the reactor containment building, as described in greater detail below.

As discussed above, the attachments 2500 of FIG. 2 comprise the cleaning device 6000. The cleaning device 6000 comprises a threaded protrusion 6100 and a cleaning portion 6300. In at least one aspect, the cleaning device 6000 is a flux thimble tube cleaning device or equivalent. In at least one aspect, the cleaning portion 6300 comprises a plurality of bristles 6200 for scrubbing the flux thimble tubes. Further, the threaded protrusion 6100 is threadably engageable with the threaded opening 2210 of the adapter 2200 of the drive cable 2000 to removably attach the cleaning device 6000 to the drive cable 2000. In at least one aspect, the drive cable 2000 is configured to move the cleaning device 6000 within the instrumentation tubes 102 and instrumentation tubing 1200, for example. In at least one aspect, the drive cable 2000 having the cleaning device 6000 attached thereto may be used to clean other types of instrumentation tubing. In any event, the modular capabilities of the multi-use drive cable 2000 allows the cleaning device 6000 to be attached to the drive cable 2000 to be periodically clean the reactor core instrumentation tubes while the reactor is in operation. In at least one aspect, the cleaning device 6000 is attachable to and detachable from the drive cable 2000 within a glove box positioned outside of the reactor containment building, as described in greater detail below.

FIG. 4 illustrates a schematic of a rabbit harvesting system (RHS) 700 in relation to a reactor containment building wall 500. In at least one aspect, the MIDS 1000 comprising one or more than one of the drive cables 2000 is used to route the attachments 2500 and/or rabbits through one or more than one of the guide tubes 800 that exit the reactor containment building through one or more than one spare feed-through penetration 600 in the reactor containment building wall 500 and into the RHS 700. The one or more than one containment penetration 600 is designed to meet all containment isolation requirements.

In use, after being positioned within the instrumentation tube 102 of the reactor core 100, the attachments 2500 and/or the rabbits are movable into the rabbit harvesting system 700 positioned at an exit of the containment penetration 600. In at least one aspect, the rabbit harvesting system 700 comprises a glove box and associated tooling, among other features. Once inside the glove box of the rabbit harvesting system 700, the irradiated rabbits and/or the attachments 2500 can be detached from the multi-use drive cable 2000. In at least one aspect, after detachment, the rabbits are placed into a shipping container. Further, the multi-use drive cable 2000 can then be attached to a fresh rabbit or any of the attachments 2500 illustrated in FIG. 2, for example. In at least one aspect, the rabbit harvesting system 700 provides atmospheric isolation to prevent the spread of loose surface and airborne radioactive contamination in the event of the failure of a device containing irradiated material during harvesting operations. In at least one aspect, the rabbit harvesting system 700 provides the capability to adjust the radiation shielding used as required to ensure the operator dose remains within planned limits during rabbit harvesting operations and/or during the attachment and/or detachment operations between any of the attachments 2500 and the drive cable 2000. In at least one aspect, placing the harvested radioisotope packages into shipping containers is also performed inside the RHS 700. In at least one aspect, the RHS 700 provides a shielded area for temporarily storing any radioactive waste generated during the radioisotope harvesting process. In addition, the RHS 700 also provides storage for fresh rabbits, the neutron detectors 3000, and/or any of the other attachments 2500 in between uses.

### Various Aspects of the Subject Matter Described Herein are Set Out in the Following Numbered Examples

Example 1—A multi-use incore system for use with a nuclear reactor is disclosed. The nuclear reactor comprises a reactor core including an instrumentation tube extending into the reactor core. The multi-use incore system comprises a drive cable, a neutron detector, an electromagnetic tool, and an irradiation target. The drive cable comprises an adapter at its distal end. The drive cable is slidably receivable into the instrumentation tube. The neutron detector is removably attachable to the adapter of the drive cable to monitor core power distribution. The neutron detector is slidably receivable into the instrumentation tube by the drive cable. The electromagnetic tool is removably attachable to the adapter of the drive cable in lieu of the neutron detector. The irradiation target is to produce a radioisotope. The drive cable is selectively attachable to the irradiation target by the electromagnetic tool to insert the irradiation target into the instrumentation tube and remove the irradiation target from the instrumentation tube.

Example 2—The multi-use incore system of Example 1, wherein the adapter comprises a threaded opening, wherein the neutron detector comprises a threaded protrusion configured to be threadably engaged with the threaded opening to attach the neutron detector to the drive cable.

Example 3—The multi-use incore system of Example 1 or 2, wherein the adapter comprises a threaded opening, wherein the electromagnetic tool comprises a threaded protrusion configured to be threadably engaged with the threaded opening to attach the electromagnetic tool to the drive cable.

Example 4—The multi-use incore system of Examples 1, 2, or 3, wherein the adapter and the drive cable comprise electrical cables therein.

Example 5—The multi-use incore system of Example 4, wherein, while the neutron detector is attached to the adapter, the neutron detector is configured to transmit a signal indicative of reactor core power distribution via the electrical cables while the neutron detector is positioned within the instrumentation tube and the reactor core is in operation.

Example 6—The multi-use incore system of Example 4 or 5, wherein, while the electromagnetic tool is attached to the adapter, the electrical cables permit power to be supplied to the electromagnetic tool to energize an electromagnet of the electromagnetic tool and permit the electromagnetic tool to attach the drive cable to the irradiation target.

Example 7—An incore system for use with a nuclear reactor is disclosed. The nuclear reactor comprises a reactor core including an instrumentation tube extending into the reactor core. The incore system comprises a drive cable, a neutron detector, a rabbit connector, and a rabbit assembly. The drive cable comprises an adapter at its distal end. The neutron detector is removably attachable to the adapter of the drive cable. The rabbit connector is removably attachable to the adapter of the drive cable in lieu of the neutron detector. The rabbit assembly is selectively attachable to the drive cable by way of the rabbit connector. The incore system is operable in a plurality of configurations. The plurality of configurations comprises a first configuration and a second configuration. In the first configuration the neutron detector is attached to the adapter and is insertable into and removable from the instrumentation tube by the drive cable. In the second configuration the rabbit connector is attached to the adapter of the drive cable, the rabbit assembly is releasably attached to the drive cable by way of the rabbit connector, and the rabbit assembly is insertable into and removable from the instrumentation tube by the drive cable.

Example 8—The incore system of Example 7, wherein the adapter comprises a threaded opening, wherein the neutron detector comprises a threaded protrusion configured to be threadably engaged with the threaded opening to attach the neutron detector to the drive cable.

Example 9—The incore system of Example 7 or 8, wherein the adapter comprises a threaded opening, wherein the rabbit connector comprises a threaded protrusion configured to be threadably engaged with the threaded opening of the adapter to attach the rabbit connector to the drive cable.

Example 10—The incore system of Examples 7, 8, or 9, wherein the rabbit connector permits the drive cable to selectively attach to and detach from the rabbit assembly to position the rabbit assembly at different locations within the instrumentation tube.

Example 11—The incore system of Examples 7, 8, 9, or 10, wherein the adapter and the drive cable comprise electrical cables therein.

Example 12—The incore system of Example 11, wherein, while the neutron detector is attached to the adapter, the neutron detector is configured to transmit a signal indicative of reactor core power distribution via the electrical cables when the neutron detector is inserted into the instrumentation tube and the reactor core is in operation.

Example 13—An incore system for use with a nuclear reactor is disclosed. The nuclear reactor comprises a reactor core including an instrumentation tube extending into the reactor core. The incore system comprises a drive cable, a neutron detector, and an irradiation target. The drive cable is movable within the instrumentation tube. The neutron detector is selectively attachable to the drive cable. The irradiation target is selectively attachable to the drive cable in lieu of the neutron detector. The incore system is operable in a plurality of configurations. The plurality of configurations comprises a first configuration and a second configuration. In the first configuration the neutron detector is attached to the drive cable and the neutron detector is slidably receivable into the instrumentation tube. In the second configuration the irradiation target is attached to the drive cable and the irradiation target is slidably receivable into the instrumentation tube.

Example 14—The incore system of Example 13, wherein in the first configuration the neutron detector is removably attachable to the drive cable by way of a threaded connection.

Example 15—The incore system of Example 13 or 14, wherein in the second configuration the irradiation target is removably attachable to the drive cable by way of a threaded connection.

Example 16—The incore system of Examples 13, 14, or 15, wherein the drive cable comprises an adapter at its distal end.

Example 17—The incore system of Example 16, wherein in the first configuration the neutron detector is removably attachable to the adapter of the drive cable.

Example 18—The incore system of Example 16, wherein in the second configuration the irradiation target is removably attachable to the adapter of the drive cable.

Example 19—The incore system of Example 16, wherein in the second configuration the irradiation target is selectively attachable to the drive cable by way of an electromagnetic tool attached to the adapter.

Example 20—The incore system of Example 13, wherein the plurality of configurations comprises a third configuration, wherein in the third configuration a flux thimble tube cleaning device is attached to the drive cable and the flux thimble tube cleaning device is slidably receivable into the instrumentation tube.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A multi-use incore system for use with a nuclear reactor, wherein the nuclear reactor comprises a reactor core including an instrumentation tube extending into the reactor core, and wherein the multi-use incore system comprises:
a drive cable comprising an adapter at its distal end, wherein the drive cable is slidably receivable into the instrumentation tube;
a neutron detector removably attachable to the adapter of the drive cable to monitor core power distribution, wherein the neutron detector is slidably receivable into the instrumentation tube by the drive cable;
an electromagnetic tool removably attachable to the adapter of the drive cable in lieu of the neutron detector; and
an irradiation target to produce a radioisotope, the drive cable is selectively attachable to the irradiation target by the electromagnetic tool to insert the irradiation target into the instrumentation tube and remove the irradiation target from the instrumentation tube.

2. The multi-use incore system of claim 1, wherein the adapter comprises a threaded opening, wherein the neutron detector comprises a threaded protrusion configured to be threadably engaged with the threaded opening to attach the neutron detector to the drive cable.

3. The multi-use incore system of claim 1, wherein the adapter comprises a threaded opening, wherein the electromagnetic tool comprises a threaded protrusion configured to be threadably engaged with the threaded opening to attach the electromagnetic tool to the drive cable.

4. The multi-use incore system of claim 1, wherein the adapter and the drive cable comprise electrical cables therein.

5. The multi-use incore system of claim 4, wherein, while the neutron detector is attached to the adapter, the neutron detector is configured to transmit a signal indicative of reactor core power distribution via the electrical cables while the neutron detector is positioned within the instrumentation tube and the reactor core is in operation.

6. The multi-use incore system of claim 4, wherein, while the electromagnetic tool is attached to the adapter, the electrical cables permit power to be supplied to the electromagnetic tool to energize an electromagnet of the electromagnetic tool and permit the electromagnetic tool to attach the drive cable to the irradiation target.

7. An incore system for use with a nuclear reactor, wherein the nuclear reactor comprises a reactor core including an instrumentation tube extending into the reactor core, and wherein the incore system comprises:
a drive cable comprising an adapter at its distal end;
a neutron detector removably attachable to the adapter of the drive cable;
a rabbit connector removably attachable to the adapter of the drive cable in lieu of the neutron detector; and
a rabbit assembly selectively attachable to the drive cable by way of the rabbit connector, wherein the incore system is operable in a plurality of configurations, and wherein the plurality of configurations comprises:
a first configuration, wherein in the first configuration the neutron detector is attached to the adapter and is insertable into and removable from the instrumentation tube by the drive cable; and
a second configuration, wherein in the second configuration the rabbit connector is attached to the adapter of the drive cable, the rabbit assembly is releasably attached to the drive cable by way of the rabbit connector, and the rabbit assembly is insertable into and removable from the instrumentation tube by the drive cable.

8. The incore system of claim 7, wherein the adapter comprises a threaded opening, wherein the neutron detector comprises a threaded protrusion configured to be threadably engaged with the threaded opening to attach the neutron detector to the drive cable.

9. The incore system of claim 7, wherein the adapter comprises a threaded opening, wherein the rabbit connector comprises a threaded protrusion configured to be threadably engaged with the threaded opening of the adapter to attach the rabbit connector to the drive cable.

10. The incore system of claim 7, wherein the rabbit connector permits the drive cable to selectively attach to and detach from the rabbit assembly to position the rabbit assembly at different locations within the instrumentation tube.

11. The incore system of claim 7, wherein the adapter and the drive cable comprise electrical cables therein.

12. The incore system of claim 11, wherein, while the neutron detector is attached to the adapter, the neutron detector is configured to transmit a signal indicative of reactor core power distribution via the electrical cables when the neutron detector is inserted into the instrumentation tube and the reactor core is in operation.

13. An incore system for use with a nuclear reactor, wherein the nuclear reactor comprises a reactor core including an instrumentation tube extending into the reactor core, and wherein the incore system comprises:
a drive cable movable within the instrumentation tube;
a neutron detector selectively attachable to the drive cable; and
an irradiation target selectively attachable to the drive cable in lieu of the neutron detector, wherein the incore system is operable in a plurality of configurations, and wherein the plurality of configurations comprises:
a first configuration, wherein in the first configuration the neutron detector is attached to the drive cable and the neutron detector is slidably receivable into the instrumentation tube; and
a second configuration, wherein in the second configuration the irradiation target is attached to the drive cable and the irradiation target is slidably receivable into the instrumentation tube.

14. The incore system of claim 13, wherein in the first configuration the neutron detector is removably attachable to the drive cable by way of a threaded connection.

15. The incore system of claim 13, wherein in the second configuration the irradiation target is removably attachable to the drive cable by way of a threaded connection.

16. The incore system of claim 13, wherein the drive cable comprises an adapter at its distal end.

17. The incore system of claim 16, wherein in the first configuration the neutron detector is removably attachable to the adapter of the drive cable.

18. The incore system of claim 16, wherein in the second configuration the irradiation target is removably attachable to the adapter of the drive cable.

19. The incore system of claim 16, wherein in the second configuration the irradiation target is selectively attachable to the drive cable by way of an electromagnetic tool attached to the adapter.

20. The incore system of claim 13, wherein the plurality of configurations comprises a third configuration, wherein in the third configuration a flux thimble tube cleaning device is attached to the drive cable and the flux thimble tube cleaning device is slidably receivable into the instrumentation tube.
